(19) United States
(12) Patent Application Publication
(10) Pub. No.: US 2009/0127131 A1
(43) Pub. Date: May 21, 2009

(54) Scale Making Method

(75) Inventors: Geoffrey McFarland, Dursley (GB); David Roberts McMurtry, Dursley (GB); Alexander David Scott Ellin, Horsley (GB)

Correspondence Address: OLIFF & BERRIDGE, PLC, P.O. BOX 320850, ALEXANDRIA, VA, 22320-4850, US

(73) Assignee: Renishaw PLC, Wotton-Under-Edge, Gloucestershire (GB)

(21) Appl. No.: 11/658,917

(22) PCT Filed: Aug. 1, 2005
(86) PCT No.: PCT/GB05/03008

§ 371 Date: Jan. 30, 2007

(30) Foreign Application Priority Data
Jul. 30, 2004 (GB) 0416952.0

(51) Int. Cl. B23H 3/00

(52) U.S. Cl. 205/641; 205/640; 205/686; 204/224 M

(57) ABSTRACT

Apparatus and method for making a metrological scale by electrochemical machining of a scale substrate using a tool having at least one feature. The method has the steps of passing an electrolyte solution between the tool and the scale substrate and forming an electrical connection between the scale substrate and the tool. Electrochemical dissolution of the scale substrate occurs adjacent to the feature of the tool to produce at least one scale marking. This is suitable for making linear, rotary and two dimensional scales.

The present invention relates to a method of making metrological scale for scale reading apparatus. In particular, the invention relates to a method of making scale by electrochemical machining.

A known form of scale reading apparatus for measuring relative displacement of two members comprises a scale on one of the members having scale marks defining a pattern and a readhead provided on the other member. An optical scale reading apparatus has means for illuminating the scale and detecting means in the readhead responsive to a resultant light pattern to produce a measure of relative displacement of the scale and readhead. A scale having its marks in a periodic pattern is known as an incremental scale and provides an output of up and down counts. A scale may be provided with reference marks which, when detected by the readhead, enable the exact position of the readhead to be determined. The scale may have absolute code marks which enable the absolute position of the readhead to be determined anywhere on the scale.

Scale and readhead systems are not limited to optical systems. Magnetic, capacitance and inductive reading systems are also known.

Metrological scales may for example be linear, rotary or two-dimensional. Rotary scales may have the scale markings provided radially on a face or axially on the circumference of a rotary part.

The scale may be an amplitude scale or a phase scale. In the amplitude scale the scale pattern is made from two different types of sections. A first type of section reflects incident light to the readhead and the second type of section does not. For example an incremental amplitude scale may comprise alternate reflecting and non-reflecting lines, such as chrome on glass scale.

A phase scale has a form that reflects light from different sections at different phases when detected at the readhead.

European Patent EP 0274492 discloses a method of making a scale by passing an elongate scale member between a pair of cylindrical rollers, one roller having a plane surface and the other roller having a profiled surface. As a scale member is passed through the rollers and pressure is applied, a surface of the scale member is deformed with the pattern of the profiled roller.

A known technique for forming a workpiece with a specified shape dimension and surface finish is electrochemical machining. This is the controlled anodic electrochemical dissolution process of a workpiece (anode) with a tool (cathode) in an electrolytic cell during an electrolysis process.

A first aspect of the invention provides a method for making a metrological scale by electrochemical machining of a scale substrate using a tool having at least one feature, the method comprising the following steps, in any suitable order:
passing an electrolyte solution between the tool and the scale substrate;
forming an electrical connection between the scale substrate and the tool such that electrochemical dissolution of the scale substrate occurs adjacent to the feature of the tool to produce at least one scale marking.

Preferably the tool and scale substrate are moved relative to one another.

The one or more sensor may be provided for sensing scale markings generated by the tool, and the method includes the step of:
using at least one sensor of the one or more sensors to sense the scale markings made on the scale substrate; and
feeding back this information to a system controller in order to control system parameters.

At least one of the one or more sensor senses the pitch, depth or width of the scale markings. The at least one of the one or more sensor may be used to determine whether any scale markings can be detected. The feedback may also used for relative placement of the tool and scale substrate for the creation of subsequent scale markings.

The reflectivity of the scale markings may be selected by adjusting the system parameters. The electrochemical dissolution may occur between scale markings to produce a polished surface. This may occur in a separate step.

In one embodiment, the method includes a tool refurbishment step. The tool refurbishment step may comprise an electrochemical machining method. The extent of protrusion of the at least one feature from the tool may adjustable. The at least one feature may be tapered.

The tool may be moveable relative to the scale substrate such that movement of the tool assists in flushing through the electrolyte.

The tool may be moved relative to the scale substrate in steps in order to produce a repeating pattern of scale markings. The tool is moved continuously relative to the scale substrate in order to produce a repeating pattern of scale markings.

The electrical connection between the scale substrate and tool may be pulsed. The pulse rate of the electrical connection may be synchronised with the relative movement of the tool and scale substrate. The method may include the step of controlling the pulse parameters in response to feedback from the one or more sensor.

The electrical connection between the scale substrate and the tool may be a continuous current.

A second aspect of the present invention provides apparatus for making a metrological scale by electrochemical machining of a scale substrate comprising;
a tool having at least one feature;
an electrolyte solution between the tool and the scale substrate;
an electrical connection between the scale substrate and the tool such that electrochemical dissolution occurs on the scale substrate adjacent the feature of the tool to produce at least one scale marking.

The scale may comprise a phase scale or an amplitude scale.

The invention will now be described with reference to the accompanying drawings in which:

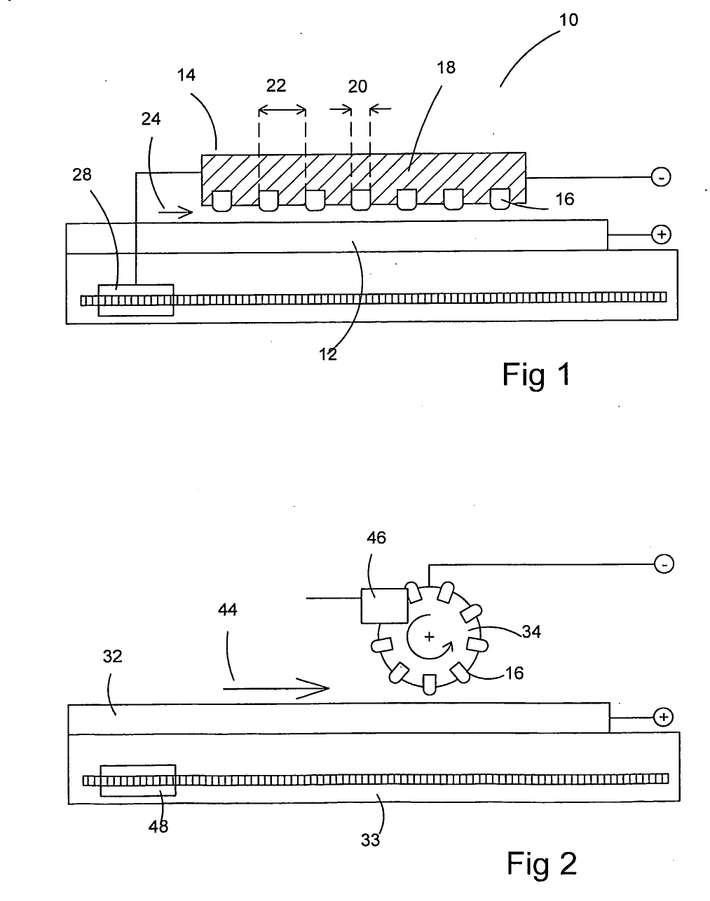

FIG. 1 is a side view of a first embodiment of scale manufacturing apparatus;

FIG. 2 is a side view of a second embodiment of the scale manufacturing apparatus;

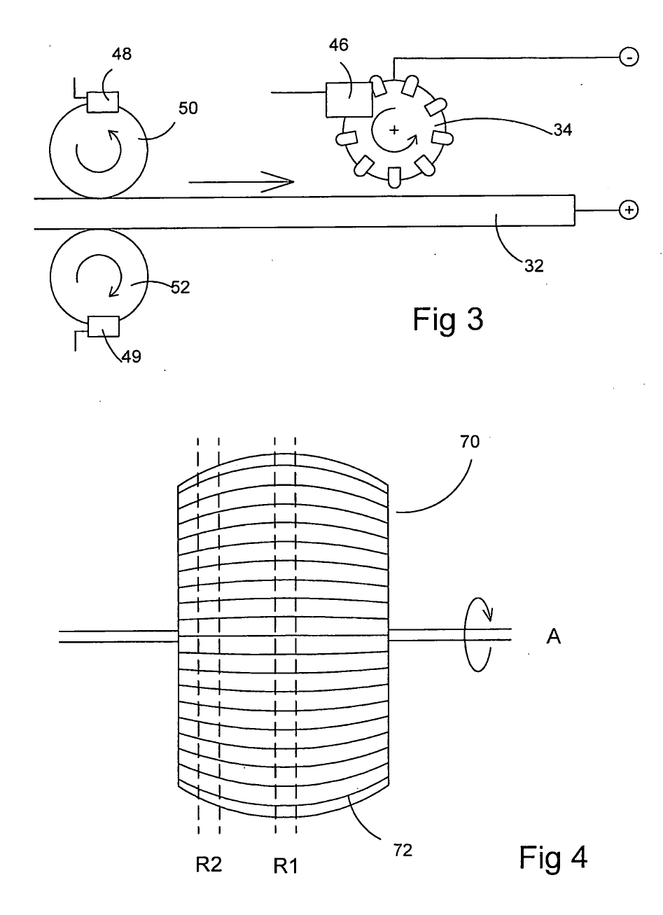

FIG. 3 illustrates a side view of a variation of the embodiment of FIG. 2 using rollers;

FIG. 4 illustrates a tool with a part spherical surface;

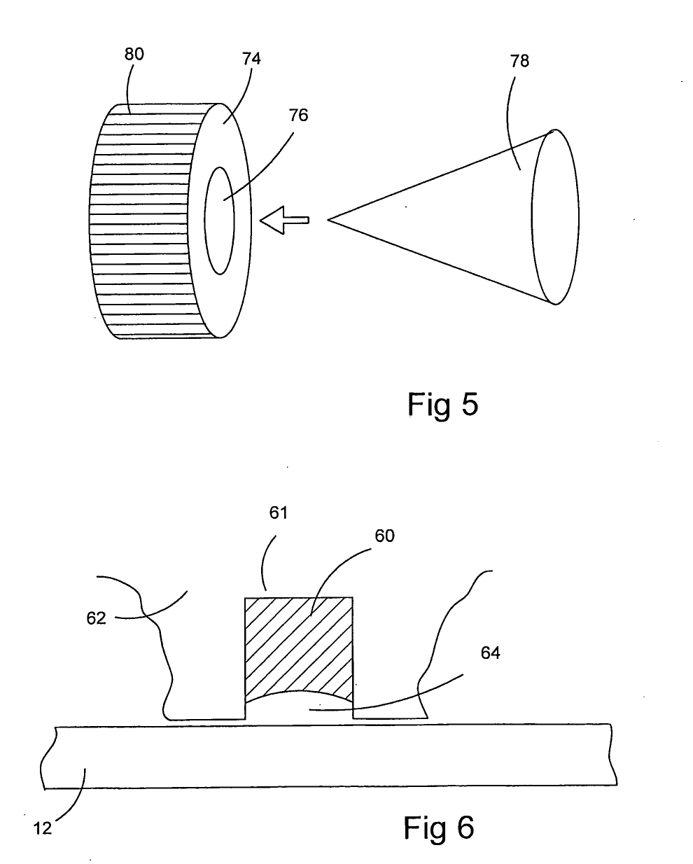

FIG. 5 illustrates a tool with a central aperture and associated mandrel;

FIG. 6 is a side view of a portion of a first embodiment of the tool design;

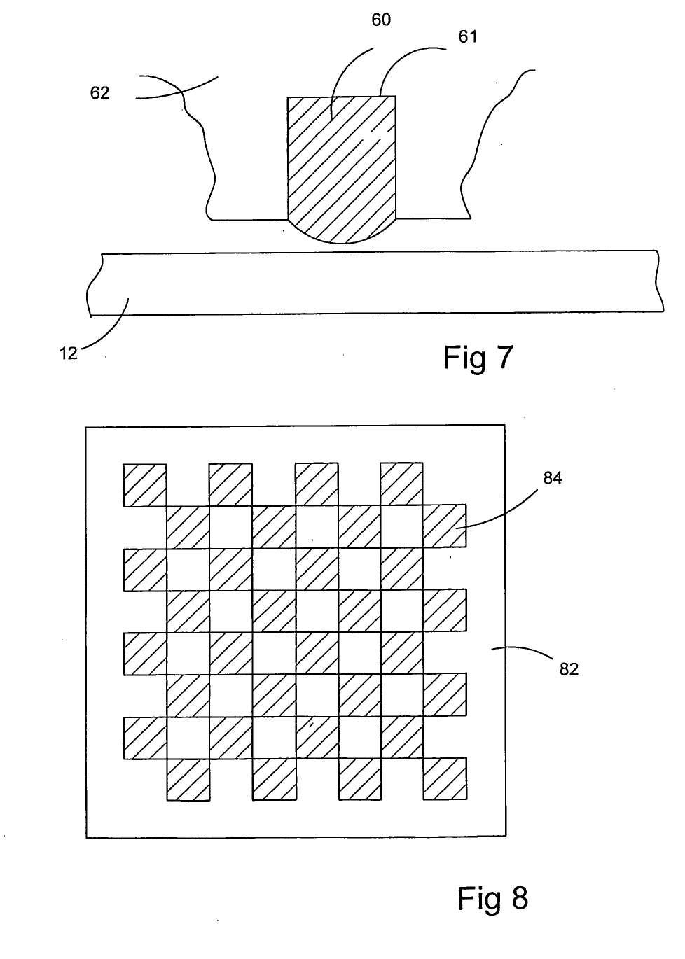

FIG. 7 is a side view of a portion of a second embodiment of the tool design;

FIG. 8 is a plan view of a tool for forming a 2D side;

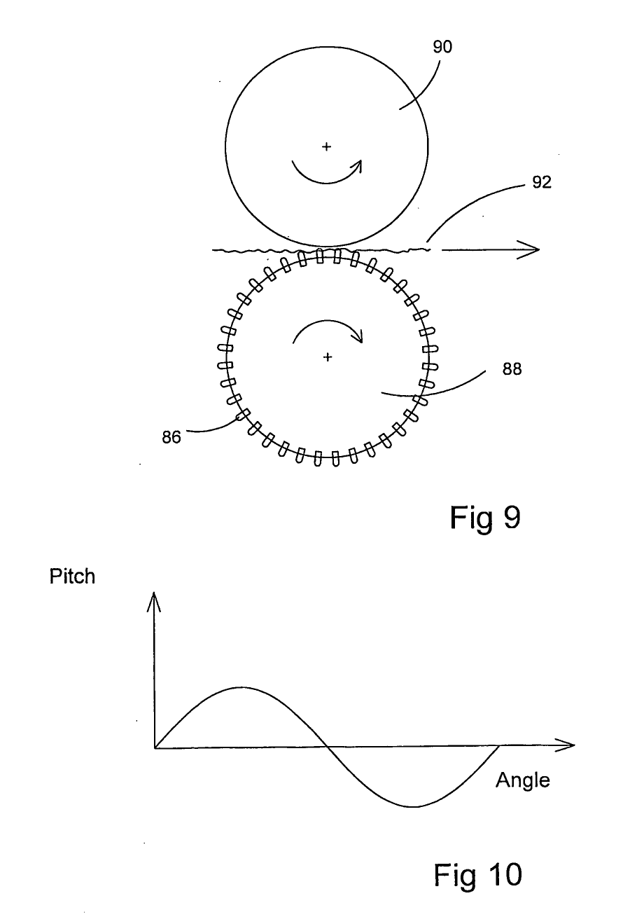

FIG. 9 is a side view of apparatus for forming a rotary scale;

FIG. 10 is a graph of pitch against angular position;

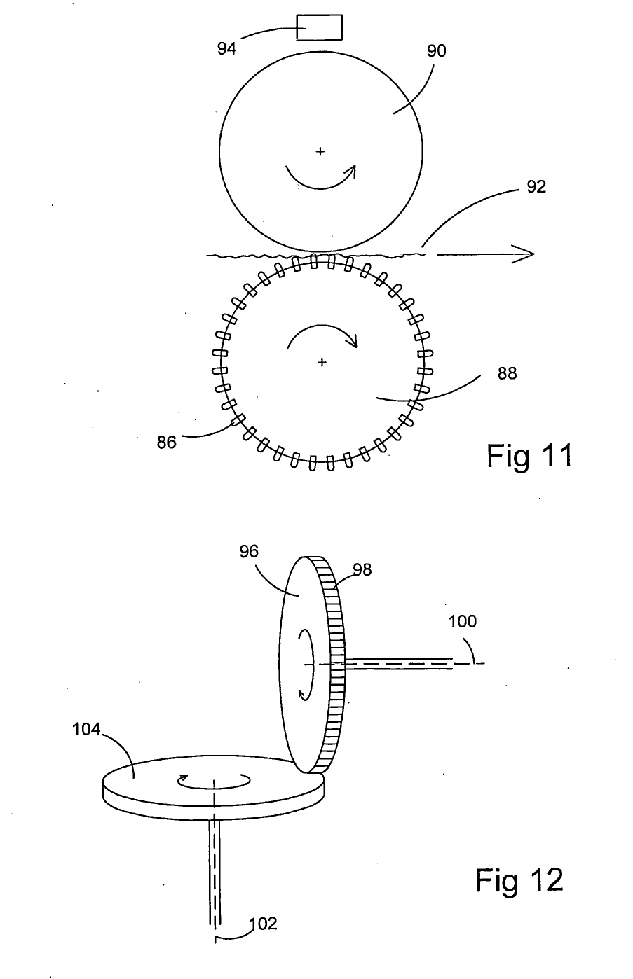

FIG. 11 illustrates the apparatus of FIG. 9 with an additional sensor;

FIG. 12 illustrates apparatus for forming scale markings on an edge of a rotary scale;

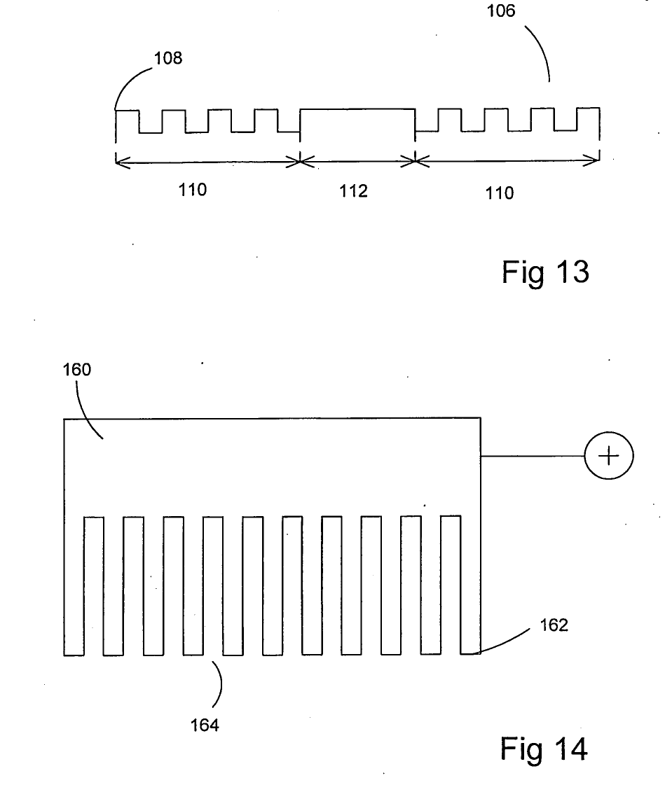

FIG. 13 illustrates a reference mark in a scale; and

FIG. 14 illustrates a tool with integral elements;

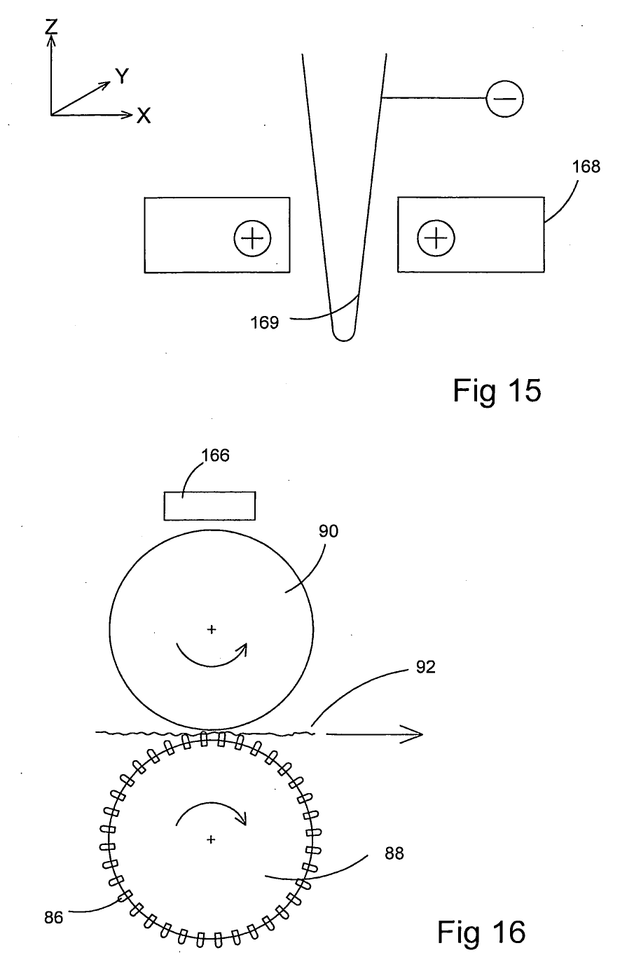

FIG. 15 illustrates apparatus for refurbishing an element;

FIG. 16 illustrates the embodiment of FIG. 9 with a tool refurbishment station;

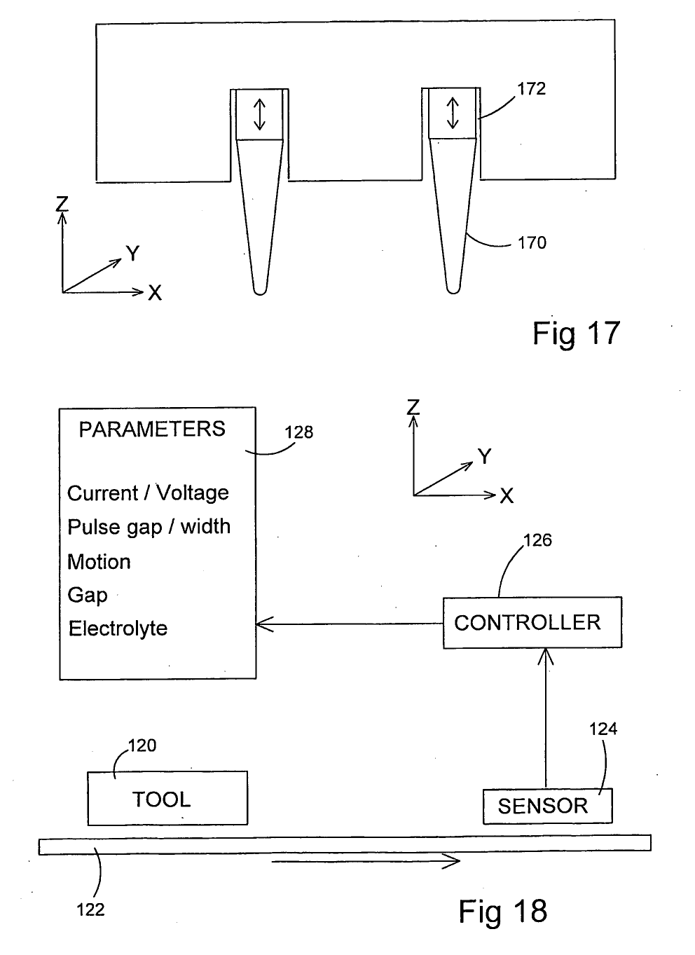

FIG. 17 illustrates a tool with movable elements;

FIG. 18 is a flow diagram of the feedback system;

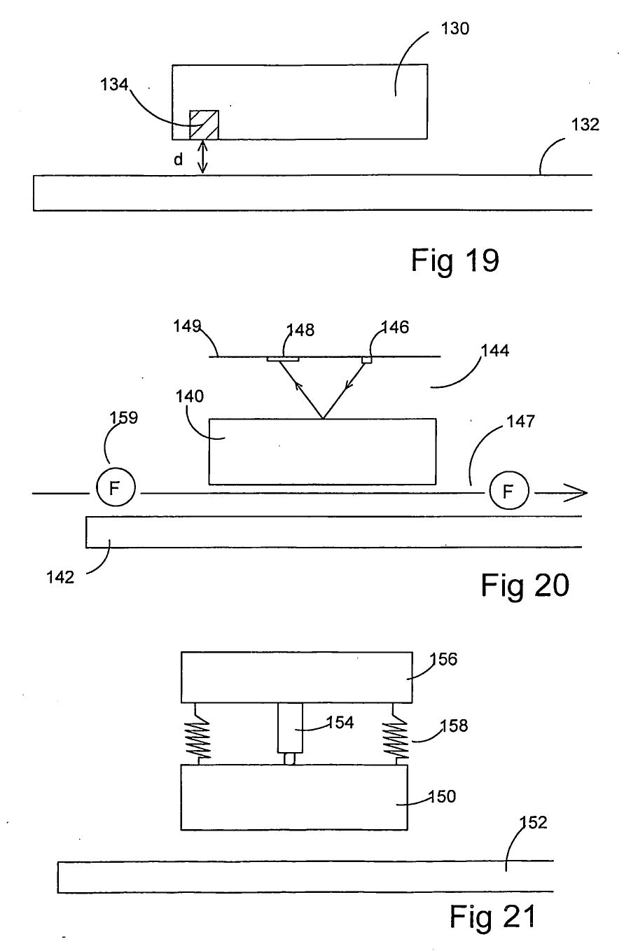

FIG. 19 is a side view of direct gap measurement system;

FIG. 20 is a side view of a first indirect gap measurement system; and

FIG. 21 is a side view of a second indirect measurement system

FIG. 1 illustrates a side view of a first embodiment of the invention. The apparatus comprises an electrolytic cell 10 in which the scale substrate 12 is an anode and the tool 14 is a cathode. The tool 14 is provided with a series of metal elements 16 embedded in a substrate 18. This may comprise a non conductive substrate. The metal elements 16 have a width 20 equal or smaller to the width of the desired scale feature. For example each metal finger may have a width of less than 4 microns. The metal elements 16 have a pitch 22 equal to the desired pitch of the scale. Alternatively the metal elements 16 may have a pitch 22 equal to n times the desired pitch of the scale. An electrolytic solution 24 is forced to flow between the scale substrate 12 and the tool 14.

Direct current is passed between the scale substrate 12 (anode) and the tool 14 (cathode), the direct current may be either continuous or pulsed. At the surface of the anodic scale substrate 12, metal is dissolved into metallic ions by a de-plating reaction. The shape of the tool 14 is thus substantially copied onto the scale substrate 12.

The tool 14 is moved along the scale substrate 12 and at each position a current is applied between the anode and cathode so that trenches are selectively etched into the scale substrate 12. The shape of the metal elements of the tool is substantially copied into the scale, thus a desired shape may be chosen. The shape of the elements may be only loosely copied onto the scale substrate. The tool may be stepped relative to the scale substrate by servo positioning one of the tool and scale substrate. The servo positioning may be velocity controlled.

If both the trenches and upper surface of the scale are reflective, then a phase scale will be produced. However, if the scale substrate is treated or manufactured so that one of the trench and upper surface is reflective and the other is non reflective, then an amplitude grating will be produced.

As the tool is moved along the scale, it is important that the tool is at the correct position when the current is applied. This may be achieved by providing an encoder 28 to measure relative position of the scale substrate and tool. Alternatively, a readhead system may be connected to the tool, so that as the system is passed over the scale markings that have been produced, the output of the readhead is used as feedback to position the tool in order that the next scale markings are produced in the correct relationship with the previous scale markings. Other sensors can be used to read the scale markings, for example a camera or surface profiler.

The sensors may also be used to determine whether the scale markings are of sufficiently good quality to be detected. This quality of the scale markings may be effected by debris, such as metal hydroxide produced by the de-plating reaction and not adequately removed by the flow of electrolyte.

If the metal elements of the tool are spaced at the pitch of the scale, then the tool is moved so that a section of the scale is made at a time. However if the pitch of the metal elements is a multiple of the pitch of the scale, then the tool must be moved in small steps so that a scale is produced with the desired pitch. Alternatively, an averaging technique may be used so that the trenches are built up on the scale substrate with successive pulses from metal elements as the tool is moved along the scale substrate.

Several system parameters effect the dimensions and quality of the scale markings produced by this method. For example, it is advantageous to have a small gap between the scale substrate and tool, typically in the range of 50-300 μm. The smaller the gap, the more defined the features on the scale substrate will be. However, a small gap may result in the electrolyte boiling and producing hydrogen gas at the anode, thus inhibiting the de-plating reaction.

This problem is overcome by monitoring the scale markings and using this information to adjust system parameters, thus maintaining optimum conditions for the production of well defined features on the scale substrate.

Parameters such as the working voltage and current between the anode and cathode, the flow rate and temperature of the electrolyte, the interval between the tool and scale substrate and the interval between electrical pulses can be closed loop controlled by feedback from the sensor reading the scale markings so that a consistent depth of material is removed from the scale substrate and so that the scale markings have the desired dimensions (e.g. width, depth and shape of feature).

FIG. 18 illustrates a feed back system. The tool 120 and scale substrate 122 are moveable relative to one another in the X direction. The tool 120 may also be movable in the Z direction. One or more sensors 124 are provided to sense the scale markings produced by the tool 120. The output from the one or more sensors 124 are sent to a controller 126 which may adjust the system parameters 128.

The system parameters are measured and most are measured by conventional means, whether directly or indirectly. FIGS. 19 and 20 illustrate methods of measuring the gap between the scale substrate and tool by direct and indirect methods respectively. FIG. 19 illustrates a tool 130 with a sensor 134 which detects the distance d from the scale substrate 132 directly, the sensor may comprise an inductance or ultrasonic detector, for example.

FIG. 20 illustrates a tool 140 using indirect means to detect the gap between the tool 140 and scale substrate 142. Optical means 144, e.g. comprising a light source 146 and detector 148, may be used to detect the distance from a surface 149 in a fixed relationship with the scale substrate 140.

These measurements of the gap may be verified by touching the tool against the scale substrate and thus providing a zero value for the gap. It can be determined when the tool is touching the scale substrate by measuring the current flowing through the system which will increase when the tool and scale substrate are in contact. Alternatively, as illustrated in FIG. 21, a microswitch 154 may be provided between the tool 150 and a supporting structure 156. Springs 158 are also provided between the tool 150 and supporting structure 156 such that on downward movement of the tool 150, the spring 158 will be compressed and microswitch will trigger when the tool comes into contact with the scale substrate. A rotating tool, as illustrated in FIGS. 2,3 and 9, may have no elements on a portion of its surface to enable the tool to contact the scale substrate at this point.

FIG. 20 shows flow meters 159 for measuring the flow rate of the electrolyte 147 entering and exiting the system.

In a second embodiment of the invention, the tool has the same profile as that described in FIG. 1, however instead of stepping the tool along the scale the tool is moved continuously relative to the scale substrate. In this embodiment the current between the anode and cathode is pulsed in order to machine the trenches in the correct position on the scale substrate. The elements can be pulsed individually or all together. A reference encoder is used to determine the relative positions of the scale substrate and the tool, so that the current can be pulsed at the correct position. As before, a sensor may be provided to read the scale markings produced by this process. Feedback from the sensor may be used to control the timing of the pulses.

In this method, each trench on the scale is machined by multiple tool elements. However, it is possible to use a single tool finger to produce the scale markings.

The elements are not necessarily isolated from the rest of the tool. FIG. 14 illustrates a profiled tool 160 which comprises integral elements 162. In this embodiment, the depth of the recesses 164 between adjacent elements 162 is sufficiently large that no de-plating reaction will occur on the scale substrate adjacent the recesses. The tool may be modified so that the depth of recess 164 is reduced, thus enabling the de-plating reaction on the scale substrate to occur adjacent both the protruding elements 162 and recesses 164 of the tool. However, the different gap between recessed and protruding parts of the tool and the scale substrates will cause different amounts of de-plating. The part of the scale substrate adjacent the protruding elements 162 on the tool have a relatively large amount of material removed and form the scale troughs, whilst the part of the scale substrate adjacent the recessed portions 164 of the tool have a relatively small amount of material removed and form the scale crests. Removing material at both the scale troughs and crests has the effect of polishing the scale substrate and providing a highly reflective surface for both the scale crests and troughs, which is suitable for a phase scale. This polishing of both the scale crests and troughs may be achieved by other means.

The polishing may take place in a separate step, e.g. the scale may be polished (e.g. by electrochemical machining) in a first step and the scale marks created in a second step (or vice versa). By adjusting the system parameters, different levels of reflectivity can be achieved. For example a slower removal rate provides a more reflective finish. Thus the reflectivity can be adjusted making this technique suitable for both amplitude and phase scales.

A third embodiment of the invention is described with reference to FIG. 2. In this embodiment the tool is a rotating tool wheel 34 with the metallic elements 36 provided on its circumference. The scale substrate 32 is mounted on a moving stage 33 which is moved relative to the rotating tool wheel 34 as the rotating tool wheel is continuously rolled over the scale. During this process an electrolytic solution 44 is passed between the rotating tool wheel 34 and the scale substrate 32.

Current between the cathode (rotating tool wheel 34) and anode (scale substrate 32) is pulsed as the rotating tool wheel 34 is continuously rolled over the scale substrate 32. A reference encoder is provided to synchronise the current pulse rate with the movement of the scale substrate 32 and rotating tool wheel 34. The reference encoder could comprise for example a rotary encoder 46 provided on the rotating tool wheel 34 which is linked to a linear encoder 48 on the moving stage 33.

Alternatively as illustrated in FIG. 3, the scale substrate 32 could be fed through a pair of rollers 50,52 to produce a continuous ribbon before it comes into contact with the rotating tool wheel 34. In this case the encoder 46 on the rotating tool wheel 34 will be locked to encoders 49 on the feed rollers 50,52. If the position of the scale substrate 32 is servo-controlled to the circumferential speed of the rotating tool wheel, then continuous current could be used.

In the embodiments illustrated in FIGS. 2 and 3, a sensor may detect the scale markings produced on the scale substrate and feedback from this sensor may be used to adjust the relative speed of the scale substrate and rotating tool wheel, thereby adjusting the pitch of the scale markings.

It may be desirable to be able to adjust the pitch of the scale markings. FIG. 4 illustrates a tool 70 having a part spherical surface. The elements 72 on the surface of the tool have a curved profile so the pitch of lines differs in regions R1 and R2. This has the result that if the tool is rotated about its axis A, features in region R1 are adjacent the scale substrate and scale markings of a first pitch are formed. However, the tool may be tilted so its axis is at an angle to the scale substrate. This causes a new region R2 of features to be adjacent the scale substrate and thus the pitch of the scale markings are adjusted.

FIG. 5 illustrates another embodiment of the tool which enables the pitch of the elements (and thus the pitch of the scale markings) to be adjusted. The tool 74 is made from a substrate which has elastic properties. An aperture 76 is provided in the centre of the tool. A tapered mandrel 78 may be inserted into the aperture, causing the circumference of the tool to expand elastically, thus increasing the pitch of the features 80. As the desired pitch is small (e.g. 20 microns) the tool may comprise a material which shows elastic behaviour over only a small range.

Any of the previous embodiments are suitable for making both continuous scale and short lengths of scale.

Although the embodiments describe moving the tool relative to the scale, it is also possible to move the scale on a stage and fix the tool.

The design of the tool will now be described in further detail. FIG. 6 illustrates a section of a first embodiment of the tool, showing one of the metallic elements. The metallic finger comprises metal 60 embedded in a track 61 of a non-conducting tool substrate 62. The surface of the metal 60 which will be placed adjacent to the scale substrate 12 is recessed. Thus, in use the tool may be placed in virtual contact with the scale substrate. When the tool is in contact with the scale substrate, the non-conducting tool substrate 62 contacts the scale substrate 12, but there is a gap 64 between the scale substrate 12 and the metal 60 embedded in the track 61. This gap 64 forms a channel through which the electrolytic fluid can flow. Thus when the tool is placed in contact with the scale substrate 12, the surface of the metal 60 in the embedded track 61 is at a fixed distance from the scale substrate 12 and the electrolytic solution is located between the anode and cathode.

FIG. 7 illustrates a second embodiment of the tool. This figure illustrates a portion of the tool showing a metal 60 embedded in a track 61 in a non-conducting tool substrate 62. The surface of the metal 60 in the embedded track 61 which will be placed adjacent to the scale substrate 12 protrudes from the non-conducting tool substrate 62. In this embodiment, when the tool is in use, no contact is made between the tool and the scale substrate. The tool must be kept at a controlled distance from the scale substrate and the electrolytic solution flows between the metal tracks.

The tool may contain channels through which the electrolyte is delivered to the scale substrate.

Electro chemical machining is also suitable for forming two dimensional scales. For small scales the tool may be provided with elements in the desired scale pattern, and the scale is formed in a single step.

For larger scales, a step and repeat method is suitable. FIG. 8 illustrates a suitable tool 82 for forming a section of a two dimensional scale. This tool may be used to form scale markings on a scale substrate as previously described. The tool is then moved in a step and repeat fashion to build up a larger two dimensional pattern of scale markings. The tool in this example has a pattern of elements 84 with the dimensions of four scale pitches by four scale pitches. It may be moved by four scale pitches at a time to build up the scale pattern. Alternatively, the tool may be moved by one pitch at a time, thus building up the scale markings step by step. This has the advantage of reducing the effect of any errors in positioning of the individual elements in the tool by averaging. The tool may be moved by half a pitch to form a solid line (the width of the tool). This may be used to form a reference mark.

Correct positioning between the tool and scale substrate may be achieved using an encoder, with respective parts placed on the tool and scale substrate.

Electrochemical machining is also suitable for manufacturing rotary scales. Rotary scales may either have axial scale markings on an edge or radial markings on a face.

FIG. 9 illustrates a first embodiment for manufacturing a rotary scale. In this embodiment the tool comprises a wheel 86 with elements 88 on its outer surface. The scale substrate comprises a disc 90. The scale disc and the tool wheel are positioned edge to edge with a gap between them. Electrolytic solution 92 flows in the gap between the scale disc and the tool wheel. This may be achieved by either submerging the tool wheel or the scale disc in the electrolytic solution.

As the tool wheel 86 and scale disc 90 are rotated, scale markings will be formed on the edge of the scale disc where it is adjacent to the elements 88 on the tool wheel.

It is important to control the relative speeds of the tool wheel and scale disc, although these speeds are not necessarily the same.

It is advantageous if the number of elements 88 on the tool wheel is not a factor of the scale pitch. Thus as the scale markings are built up over several rotations, a different tool element will act on each scale marking during each rotation. Thus any errors due to the spacing of the scale marking are averaged out.

The tool may be arranged to have elements which are not spaced at every scale pitch (e.g. they may be spaced every 20^{th} or 50^{th} scale marking), so that the intervening scale markings are filled in during subsequent rotations. This has the advantage that errors caused by indexing (i.e. relative positions of rotation of the scale disc and tool wheel) are averaged out.

The scale disc may have a fundamental error trace, for example as illustrated in FIG. 10. By putting e.g. a sinusoidal speed variation in the tool wheel, this error can be substantially removed.

Both the scale disc and the tool wheel are provided with encoding means so that their relative speeds can be determined.

A readhead may be provided to read the scale markings produced on the rotary disk, as illustrated in FIG. 11. The readhead 94 is used to determine the pitch of the scale markings produced during this process. If scale markings are produced in slightly the wrong place, the scale markings may be adjusted on subsequent revolutions. For example, the scale marking may be made wider to move the centre of gravity of the scale marking to the correct position.

Scale markings may also be produced on a face of a scale disc. FIG. 12 illustrates apparatus for forming radial scale markings on a face of a rotary disc. The tool wheel 96 is provided with elements 98 around the circumference of its outer edge. These elements are parallel to one another. The axis 100 of the tool wheel is perpendicular to the axis 102 of the scale disc 104. The tool wheel and scale disc are arranged with a surface of the outer edge of the tool wheel adjacent an edge of an upper face of the scale disc, with a small gap between them through which electrolyte flows.

On rotation of the scale disc and tool wheel, scale. markings will be produced. These will be parallel lines with tapered gaps.

In an alternative embodiment suitable for both linear and rotary scales, the tool has a single element mounted on a piezo electric stage. As the scale substrate moves relative to the tool, the piezo electric stage will move in a saw tooth profile so that the element keeps stationary with respect to the scale marking being produced. The element then returns to its original position and repeats this process for the next scale marking. The stage may include a feeder to feed the element towards the scale substrate should the element degrade.

Although the embodiments above describe an incremental scale pattern, these methods are also suitable for providing other patterns, such as reference marks or absolute scale patterns. In this case the scale elements may be arranged in the desired pattern, so that this pattern is imprinted onto the scale.

A reference mark may be provided in the scale by several methods. In a first method, the tool may not receive an electric pulse when positioned over a region of the scale substrate, so that no scale markings are formed in that region. FIG. 13 illustrates a portion of scale 106 with scale markings 108 forming an incremental pattern 110 and a reference mark 112. In another method, relative movement of the tool is stopped so that a region of the scale remains in contact with an element on the tool and thus a region of continuous scale markings is formed. For example, in the embodiments illustrated in FIGS. 2,3 and 9, this is achieved by stopping rotation of the tool wheel.

A chirp scale (of varying pitch) may be formed using the embodiment illustrated in FIGS. 2,3 and 9 by varying the speed of the tool wheel relative to the scale substrate. This chirp scale may be used as a reference mark.

Absolute scale patterns can be formed on the scale substrate by a variety of techniques. A simple technique is to provide the tool with elements positioned in the pattern which is to be copied onto the scale substrate.

An absolute pattern can be formed on the scale substrate using the embodiments illustrated in FIGS. 2,3 and 9 by continuously rotating the tool wheel and pulsing the tool only when scale markings are desired. By rotating the tool wheel at twice the rate of rotation of the scale disc, scale markings can be placed side by side on the scale disc, thus producing a region of continuous scale markings.

For the formation of an iron based scale substrate, a suitable electrolyte is a chloride solution in water, for example a 10% NaCl solution. The tool material may typically comprise copper, brass or steel. An advantage of this method is that there is very little tool wear. The gap between the tool features and scale substrate is typically 50-3000 μm.

The system typically works when a voltage range of 5-300V and a current range of 50-40,000 A.

The electrolyte is typically at a temperature of 20-50° C., with a flow rate of typically 1 L/Min/100 A, a velocity of 1500-3000M/Min, inlet pressure of 0.15-3 Mpa and outlet pressure of 0.1-0.3 Mpa.

As the tools in the embodiments described have small elements, it is advantageous to provide a tool regeneration process for keeping the tool elements in optimum condition.

FIG. 15 illustrates a tapered tool element 169. In normal use, this element forms the cathode. The tool element is mounted on a stage which enables the element to move in Z, so that the element 169 can be moved downwards as it wears. The element 169 can be re-shaped using a de-plating reaction. The element 169 will now become an anode and adjacent features 168 in the tool are a cathode. The same electrolyte is used as in the scale de-plating method. Channels are provided in the tool to allow the electrolyte to circulate between the anode and the cathode.

A rotating tool wheel of the type described with reference to FIGS. 2,3 and 9 may include a tool refurbishment station so that the elements may be refurbished during each rotation. FIG. 16 illustrates the embodiment of FIG. 9 with a tool refurbishment station 166. The tool refurbishment station 164 may be as described above. Preferably the tool refurbishment station is located so that the de-plating reaction at the scale substrate and at the tool refurbishment station are out of phase so that the electrical current can be reversed between the de-plating reaction at the scale substrate and the tool refurbishment. Other methods of refurbishing the tool are possible, such as laser shaping, plating, grinding and etching.

FIG. 17 illustrates a further embodiment in which the tool is capable of moving up and down relative to the scale substrate, for example by mounting the tool or individual elements on a servo motor, piezo system or a linear motor or mounting the scale substrate on a servo motor. FIG. 17 illustrates individual elements 170 mounted on a piezo system 172. As the tool is vibrated up and down, it assists in flushing the electrolyte through the gap between the tool and scale substrate. This has the advantage in dislodging gas bubbles forming at the electrodes and flushing out debris (e.g. insoluble metal hydroxides formed during the de-plating process).

This embodiment has the further advantage that by adjusting the gap between the scale substrate and tool, the amount of de-plating at the scale substrate can be controlled, thus controlling the shape of the scale substrate. The tool can thus be servoed in Z as the scale substrate moves relative to the tool, to create the desired scale profile.

Thus large sinusoidal relative movement of the tool provides flushing of the electrolyte whilst small movement enables the gap between the scale substrate and tool to be adjusted. This relative movement of the tool and scale substrate up and down may be controlled by closed loop feedback or open loop motion.

Electrochemical machining forms a good surface finish, unlike processes such as chemi-etching which tends to leave a pitted granular surface. Electrochemical machining is a good method for polishing surfaces. It can be used to provide a highly reflective surface on both the crests and troughs of the scale, thus being suitable for producing phase scales.

1. A method for making a metrological scale by electrochemical machining of a scale substrate using a tool having at least one feature, the method comprising the following steps, in any suitable order:
passing an electrolyte solution between the tool and the scale substrate;
forming an electrical connection between the scale substrate and the tool such that electrochemical dissolution of the scale substrate occurs adjacent to the feature of the tool to produce at least one scale marking.

2. A method according to claim 1 wherein the tool and scale substrate are moved relative to one another.

3. A method according to claim 1 wherein one or more sensor is provided for sensing scale markings generated by the tool, and the method includes the step of:
using at least one sensor of the one or more sensors to sense the scale markings made on the scale substrate; and
feeding back this information to a system controller in order to control system parameters.

4. A method according to claim 3 wherein at least one of the one or more sensor senses the pitch of the scale markings.

5. A method according to claim 3 wherein at least one of the one or more sensor senses the depth of the scale markings.

6. A method according to claim 3 wherein at least one of the one or more sensor senses the width of the scale markings.

7. A method according to claim 3 wherein at least one of the one or more sensor is used to determine whether any scale markings can be detected.

8. A method according to claim 2 wherein the feedback is used for relative placement of the tool and scale substrate for the creation of subsequent scale markings.

9. A method according to claim 1 wherein the reflectivity of the scale markings is selected by adjusting the system parameters.

10. A method according to claim 1 wherein the electrochemical dissolution occurs between scale markings to produce a polished surface.

11. A method according to claim 1 wherein the method includes a tool refurbishment step.

12. A method according to claim 11 wherein the tool refurbishment step comprises an electrochemical machining method.

13. A method according to claim 11 wherein the extent of protrusion of the at least one feature from the tool is adjustable.

14. A method according to claim 11 wherein the at least one feature is tapered.

15. A method according to claim 1 wherein the tool is moveable relative to the scale substrate such that movement of the tool assists in flushing through the electrolyte.

16. A method according to claim 1 wherein the tool is moved relative to the scale substrate in steps in order to produce a repeating pattern of scale markings.

17. A method according to claim 1 wherein the tool is moved continuously relative to the scale substrate in order to produce a repeating pattern of scale markings.

18. A method according to claim 1 wherein the electrical connection between the scale substrate and tool is pulsed.

19. A method according to claim 18 wherein the pulse rate of the electrical connection is synchronised with the relative movement of the tool and scale substrate.

20. A method according to claim 18 including the step of controlling the pulse parameters in response to feedback from the one or more sensor.

21. A method according to claim 1 wherein the electrical connection between the scale substrate and the tool is a continuous current.

22. Apparatus for making a metrological scale by electrochemical machining of a scale substrate comprising;
a tool having at least one feature;
an electrolyte solution between the tool and the scale substrate;
an electrical connection between the scale substrate and the tool such that electrochemical dissolution occurs on the scale substrate adjacent the feature of the tool to produce at least one scale marking.

23. Apparatus according to claim 22 wherein the scale comprises a phase scale.

24. Apparatus according to claim 22 wherein the scale comprises an amplitude scale.

25. Apparatus according to claim 22 wherein the tool and scale substrate are movable relative to one another.

26. Apparatus according to claim 22 wherein one or more sensor is provided for sensing scale markings generated by the tool;
and wherein a feedback system is provided for feeding back information from the one or more sensor to a system controller in order to control system parameters.

27. Apparatus according to claim 26 wherein at least one of the one or more sensor senses the pitch of the scale markings.

28. Apparatus according to claim 26 wherein at least one of the one or more sensor senses the depth of the scale markings.

29. Apparatus according to claim 26 wherein at least one of the one or more sensor senses the width of the scale markings.

30. Apparatus according to claim 26 wherein at least one of the one or more sensor is used to determine whether any scale markings can be detected.

31. Apparatus according to claim 26 wherein the tool and scale substrate are moveable relative to each other, the feedback system being used for relative placement of the tool and scale substrate for the creation of subsequent scale markings.

32. Apparatus according to claim 21 wherein the system parameters are adjusted to select the reflectivity of the scale markings.

33. A method according to claim 1 wherein the system parameters are selected so that electrochemical dissolution occurs between scale markings to produce a polished surface.

34. Apparatus according to claim 22 wherein the method includes a tool refurbishment station.

35. Apparatus according to claim 34 wherein the tool refurbishment station comprises an electrochemical machining station.

36. Apparatus according to claim 34 wherein the extent of protrusion of the at least one feature from the tool is adjustable.

37. Apparatus according to claim 34 wherein the at least one feature is tapered.

38. Apparatus according to claim 22 wherein the tool is moveable relative to the scale substrate such that movement of the tool assists in flushing through the electrolyte.

39. Apparatus according to claim 22 wherein the tool and scale substrate are movable relative to each other such that the tool is moveable relative to the scale substrate in steps in order to produce a repeating pattern of scale markings.

40. Apparatus according to claim 22 wherein the tool and scale substrate are movable relative to each other such that the tool is moveable continuously relative to the scale substrate in order to produce a repeating pattern of scale markings.

41. Apparatus according to claim 22 wherein the electrical connection between the scale substrate and tool is pulsed.

42. Apparatus according to claim 41 wherein the pulse rate of the electrical connection is synchronised with the relative movement of the tool and scale substrate.

43. Apparatus according to claim 41 including a controller for controlling the pulse parameters in response to feedback from the one or more sensor.

44. Apparatus according to claim 22 wherein the electrical connection between the scale substrate and the tool is a continuous current.
